(19) United States
(12) Patent Application Publication
(10) Pub. No.: US 2024/0370776 A1
(43) Pub. Date: Nov. 7, 2024

(54) TECHNIQUES FOR MONITORING MACHINE LEARNING MODEL PERFORMANCE

(71) Applicant: VIANAI SYSTEMS, INC., Palo Alto, CA (US)

(72) Inventors: Srikar SRINATH, Palo Alto, CA (US); Navin BUDHIRAJA, Palo Alto, CA (US); Brian CUMMISKEY, Collinsville, CT (US); Matthew HUG, Orlando, FL (US); David INWALD, Berkley, MI (US); Jeremy JIANG, Santa Clara, CA (US); Yooyoung KO, Mountain View, CA (US); Tao LIU, Saratoga, CA (US); Thomas J. MARTIN, JR., Oviedo, FL (US); Wasim SADIQ, Pullenvale (AU)

(21) Appl. No.: 18/651,433

(22) Filed: Apr. 30, 2024

Related U.S. Application Data
(60) Provisional application No. 63/499,449, filed on May 1, 2023.

(51) Int. Cl. G06N 20/00

(52) U.S. Cl. CPC G06N 20/00

(57) ABSTRACT

One embodiment of a method for monitoring performance of a trained machine learning model includes receiving at least one of one or more first inputs or one or more first outputs of the trained machine learning model during a first time period, receiving at least one of one or more second inputs or one or more second outputs of the trained machine learning model during a second time period, and computing a data drift score based on the at least one of the one or more first inputs or the one or more first outputs, the at least one of the one or more second inputs or the one or more second outputs, and a predefined policy.

### CROSS-REFERENCE TO RELATED APPLICATIONS

This application claims priority benefit of the United States Provisional Patent Application titled, “TECHNIQUES FOR MONITORING PERFORMANCE OF A MACHINE LEARNING MODEL,” filed on May 1, 2023, and having Ser. No. 63/499,449. The subject matter of this related application is hereby incorporated herein by reference.

### BACKGROUND

### Field of the Various Embodiments

Embodiments of the present disclosure relate generally to machine learning, artificial intelligence (AI), and machine learning, and, more specifically, to techniques for monitoring machine learning model performance.

### DESCRIPTION OF THE RELATED ART

Machine learning (ML) can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data and/or other similar data.

Training is the process of causing a ML model to learn from data, which is referred to as “training data,” using a learning algorithm. After an ML model achieves a desired level of performance during training, the ML model can be deployed into a production environment in which the ML model makes predictions based on new data, such as real-world data points. However, in some cases, the performance of a trained ML model can worsen when the ML model runs in a production environment. For example, when real-world data that is input into the ML model in the production environment differs significantly from data that was used to train the ML model, the performance of the ML model in the production environment can worsen relative to the performance of the ML during training.

One conventional approach for evaluating the performance of a trained ML model in a production environment is to compare outputs of the ML model with ground truth data that is considered accurate. For example, the ground truth data could be collected through direct measurements and observations in the real world. One drawback of this approach for evaluating the performance of a trained ML model is that ground truth data is oftentimes not readily available in production environments. Currently, no effective techniques exist for monitoring the performance of a ML model running in a production environment without the use of ground truth data. Accordingly, users oftentimes have difficulty determining whether ML models running in production environments need to be updated or replaced due to performance issues.

As the foregoing illustrates, what is needed in the art are more effective techniques for monitoring the performance of ML models running in production environments.

### SUMMARY

One embodiment of the present disclosure sets forth a computer implemented method for monitoring performance of a trained machine learning model. The method includes receiving at least one of one or more first inputs or one or more first outputs of the trained machine learning model during a first time period. The method further includes receiving at least one of one or more second inputs or one or more second outputs of the trained machine learning model during a second time period. In addition, the method includes computing a data drift score based on the at least one of the one or more first inputs or the one or more first outputs, the at least one of the one or more second inputs or the one or more second outputs, and a predefined policy.

One technical advantage of the disclosed techniques relative to the prior art is that the disclosed techniques can be used to monitor the performance of ML models running in production environments, even when ground truth data is unavailable or partially available. In addition, the disclosed techniques are able to identify relatively slow drifts in data distributions by computing metrics over relatively long time intervals. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the computing device of FIG. 1, according to various embodiments;

FIG. 3 is a more detailed illustration of the machine learning (ML) monitoring application of FIG. 1, according to various embodiments;

FIG. 4 illustrates an exemplar user interface generated by the ML monitoring application of FIG. 1, according to various embodiments; and

FIG. 5 is a flow diagram of method steps for monitoring the performance of a machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

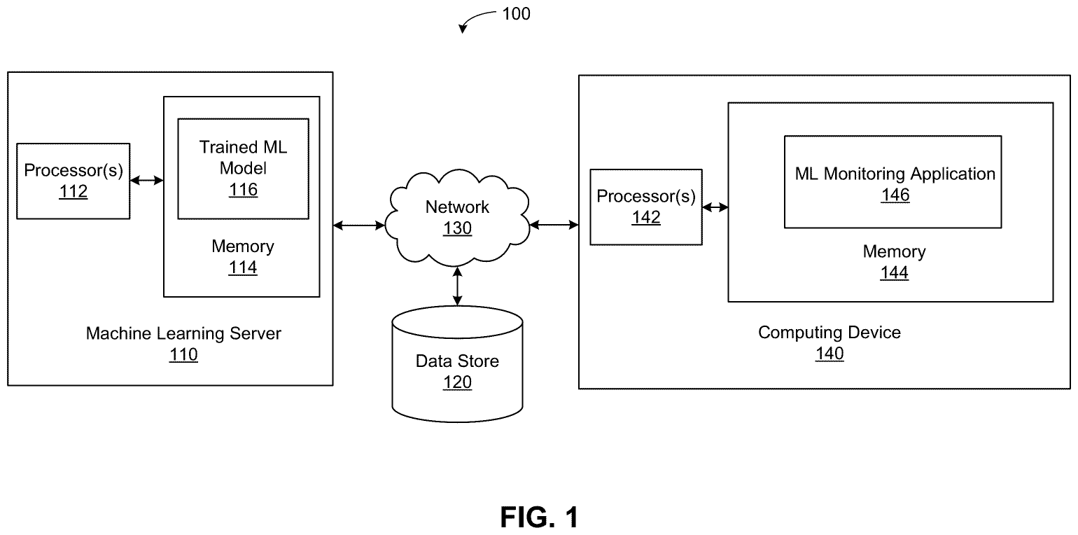

FIG. 1 illustrates a block diagram of a computer-based system 100 configured to implement one or more aspects of the various embodiments. As shown, system 100 includes a machine learning server 110, a data store 120, and a computing device 140 in communication over a network 130, which can be a wide area network (WAN) such as the Internet, a local area network (LAN), a cellular network, and/or any other suitable network.

Machine learning server 110 includes, without limitation, one or more processors 112 and a memory 114. Processor(s) 112 receive user input from input devices, such as a keyboard or a mouse. Processor(s) 112 may include one or more primary processors that control and coordinate the operations of the other system components within the machine learning server 110. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

As also shown, system memory 114 includes a trained machine learning (ML) model 116. Trained ML model 116 can be any technically feasible ML model that receives input data and generates predictions based on the input data. Trained ML model 116 can be trained for any purpose and using any suitable training technique, such as supervised, unsupervised, and/or reinforcement learning. In various embodiments, trained ML model 116 can be implemented as any technically feasible machine learning model, including, but not limited to, a neural network (e.g., a language model), a decision tree, a support vector machine, or a ensemble technique.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

Computing device 140 includes, without limitation, processor(s) 142 and a memory 144. Processor(s) 142 receive user input from input devices, such as a keyboard or a mouse. Similar to processor(s) 112 of machine learning server 110, in some embodiments, processor(s) 142 can include one or more primary processors that control and coordinate the operations of the other system components within the computing device 140. In particular, processor(s) 142 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Similar to system memory 114 of machine learning server 110, system memory 144 of computing device 140 stores content, such as software applications and data, for use by the processor(s) 142 and the GPU(s) and/or other processing units. System memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 144. The storage can include any number and type of external memories that are accessible to processor(s) 142 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

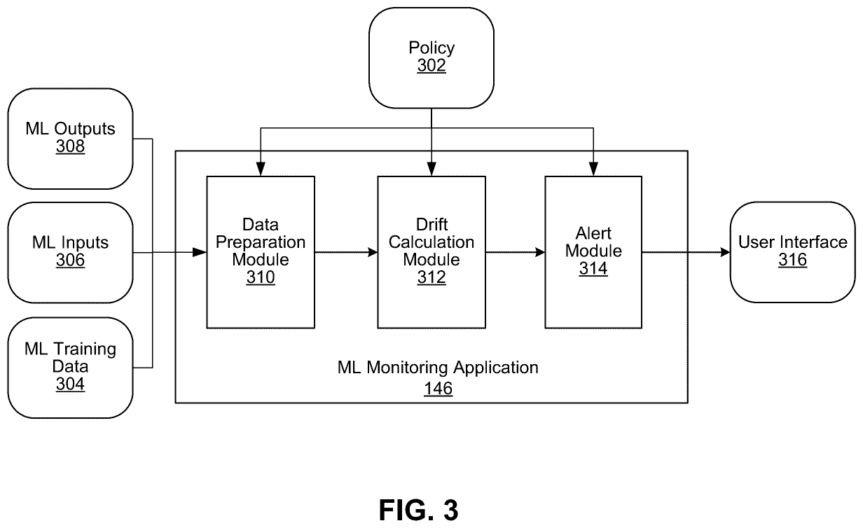

As also shown, system memory 142 includes ML monitoring application 146 that monitors ML model performance and generates alerts using default parameters or parameters set by a user. ML monitoring application 146 generates alerts when a data drift (also referred to herein a “drift”) occurs in a production environment in which a trained ML model (e.g., trained ML model 116) is deployed. As used herein, drift refers to a change in the statistical properties of data, such as ML model input data and/or ML model output data after a trained ML model is deployed. Due to such changes, the accuracy of predictions by the ML model can start to degrade if the ML model was trained on a dataset with different properties. In some embodiments, ML monitoring application 146 receives and stores data that is input into and output by trained ML model 116 over time. ML monitoring application 146 determines data drift based on the input and/or output data in different time periods. In some embodiments, ML monitoring application 146 allows users to specify shorter or longer time periods, as well as whether drift determinations are over all data or a portion of data, which is referred to herein as a “segment” of data. ML monitoring application 146 also allows users to select metrics used to compute a drift, as well as threshold(s) to trigger alerts. In some embodiments, when an alert is triggered, the user can investigate, understand, and resolve the alert, after which a summary of drift scores and ML model performance metrics provided by the ML monitoring application 146 can be updated. The operations performed by ML monitoring application 146 are described in greater detail below in conjunction with FIG. 3.

Data store 120 provides non-volatile storage for applications and data in machine learning server 110 and computing device 140. For example, and without limitation, training data, trained (or deployed) machine learning models, data that is input into and/or output by trained machine learning model, and/or application data, may be stored in data store 120. In some embodiments, data store 120 may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. Data store 120 can be a network attached storage (NAS) and/or a storage area-network (SAN). Although shown as accessible over network 130, in various embodiments, machine learning server 110 or computing device 140 can include data store 120.

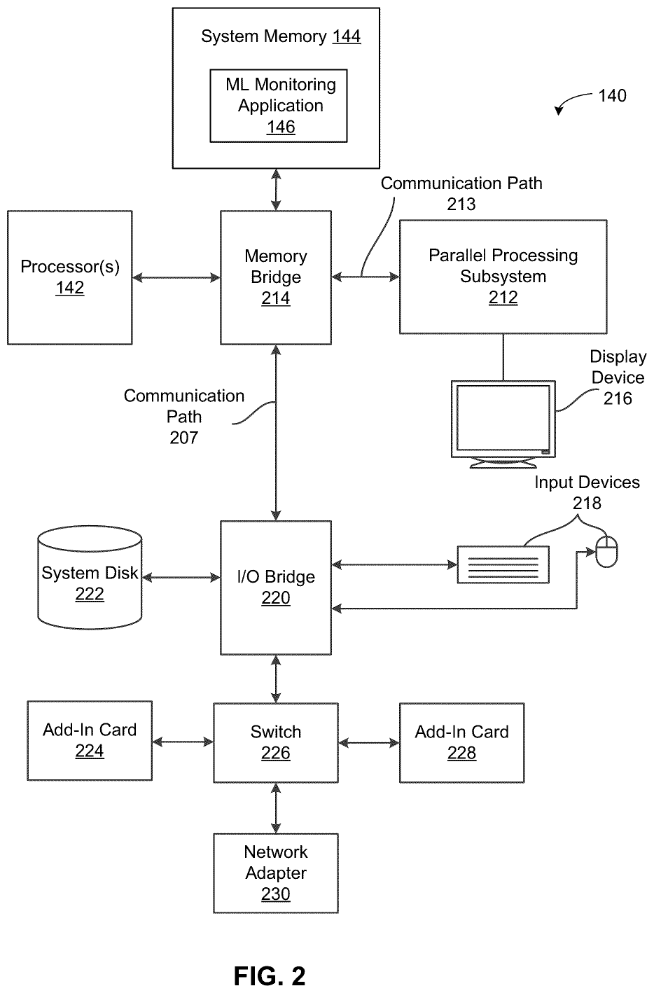

FIG. 2 is a more detailed illustration of computing device 140 of FIG. 1, according to the various embodiments. Computing device 140 may be any type of computing device, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

As shown, computing device 140 includes, without limitation, processor(s) 142 and memory (ies) 144 coupled to a parallel processing subsystem 212 via a memory bridge 214 and a communication path 213. Memory bridge 214 is further coupled to an I/O (input/output) bridge 220 via a communication path 207, and I/O bridge 220 is, in turn, coupled to a switch 226.

In various embodiments, I/O bridge 220 is configured to receive user input information from optional input devices 218, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server in a cloud computing environment. In such embodiments, computing device 140 may not include input devices 218, but may receive equivalent input information by receiving commands (e.g., responsive to one or more inputs from a remote computing device) in the form of messages transmitted over a network and received via the network adapter 230. In some embodiments, switch 226 is configured to provide connections between I/O bridge 220 and other components of the computing device 140, such as a network adapter 230 and various add-in cards 224 and 228.

In some embodiments, I/O bridge 220 is coupled to a system disk 222 that may be configured to store content and applications and data for use by processor(s) 142 and parallel processing subsystem 212. In some embodiments, system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 220 as well.

In various embodiments, memory bridge 214 may be a Northbridge chip, and I/O bridge 220 may be a Southbridge chip. In addition, communication paths 207 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 216 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 144 includes at least one device driver configured to manage the processing operations of the one or more PPUs within parallel processing subsystem 212.

In addition, system memory 144 includes ML monitoring application 146 that provides a flexible way to monitor and observe ML model performance from different dimensions, for example, different time periods or portions of data (i.e., segments). In some embodiments, ML monitoring application 146 can monitor different types of drifts, for example, a feature drift which is a distribution drift for selected raw data and/or features derived from raw data, a prediction drift which is a distribution drift for predictions output by a ML model, a label drift which is a drift for ML model ground truth data, and/or a concept drift which is drift for ML model ground truth data with respect to model inputs and/or outputs. In some embodiments, ML monitoring application 146 is configured to monitor any suitable drift requested by a user. The operations performed by ML monitoring application 146 are described in greater detail below in conjunction with FIGS. 3-5.

In various embodiments, parallel processing subsystem 212 may be integrated with one or more of the other elements of FIG. 2 to form a single system. For example, parallel processing subsystem 212 may be integrated with processor 702 and other connection circuitry on a single chip to form a system on a chip (SoC).

In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 212, may be modified as desired. For example, in some embodiments, system memory 144 could be connected to processor(s) 142 directly rather than through memory bridge 214, and other devices may communicate with system memory 144 via memory bridge 214 and processor(s) 142. In other embodiments, parallel processing subsystem 212 may be connected to I/O bridge 220 or directly to processor(s) 142, rather than to memory bridge 214. In still other embodiments, I/O bridge 220 and memory bridge 214 may be integrated into a single chip instead of existing as one or more discrete devices. In certain embodiments, one or more components shown in FIG. 2 may not be present. For example, switch 226 could be eliminated, and network adapter 230 and add-in cards 224, 228 would connect directly to I/O bridge 220. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Monitoring Machine Learning Model Performance

FIG. 3 is a more detailed illustration of ML monitoring application 146 of FIG. 1, according to various embodiments. As shown, ML monitoring application 146 includes, without limitation, a data preparation module 310, a drift calculation module 312, and an alert module 314. In operation, ML monitoring application 146 receives a user-defined policy 302, ML inputs 306, ML outputs 308, and optionally ML training data 304. ML monitoring application 146 processes such inputs to detect drifts and generates a user interface 316 to display alerts associated with the detected drifts.

Policy 302 includes configuration parameters that specify how an ML model is monitored. The configuration parameters can include baseline and target time periods, data segments, features to compute drifts for, weightings of the features, comparison metrics, thresholds used for triggering alerts, and/or the type of drift being monitored. The baseline and target time periods are the timeframes that ML monitoring application 146 uses for comparing data that is input into and/or output from the ML model to determine performance and drifts. For example, the target time period could be one month, and the baseline time period could be a previous month. As another example, the baseline time period could be the month-to-date period, and the baseline time period could be a previous month. In some embodiments, the baseline and target time periods can be the same length of time or different lengths of time. It should be noted that slow changes to data may only be evident using longer time period (e.g., month-to-month or quarter-to-quarter) comparisons of input and/or output data, whereas quicker changes to data may require a shorter time period (e.g., week-to-week) comparison. In some embodiments, a user is permitted to specify the baseline and target time periods in police 302.

Data segments include a subset of data being monitored for drifts. For example, in the case of bank data, data segments could be defined for each bank, bank branch, client of a bank, and/or the like. As another example, in the case of a taxi fare prediction model that predicts taxi fare amounts, a data segment could be data for trips from a particular area to another area.

The features for comparison can include data that is input into and/or output by a trained ML model, and/or features that are derived from such data. Returning to the example of a taxi fare prediction model, the features could include the pickup location, the destination location, the map distance, the estimated travel time, and/or the like. As another example, in the case of a language model, such as a large language model (LLM), the features could include the sentiment of user questions and/or answers generated by the language model, the length of user questions and/or generated answers, the complexity of user questions and/or generated answers, features (e.g., clusters) that are derived from embeddings of user questions and/or generated answers, and/or features that are derived from user behaviors, such as how often users ask questions, whether users asked follow-up questions, how users rated generated answers, and/or the like. As yet another example, in the case of a machine learning model that processes images, the features could include the number of objects in the images, the color distribution in the images, the contrast ratio of the images, and/or the like.

Comparison metrics can include any function or functions that quantify the performance of the ML model or compute the magnitude of drift. Examples of comparison metrics for measuring the performance of regression ML models include Mean Square Error (MSE), Mean Absolute Error (MAE), Mean Average Precision (MAP). Examples of comparison metrics for measuring the performance of classification ML models include accuracy and precision. To compute the magnitude of a drift, techniques, such as Population Stability Index (PSI) and Jensen-Shannon divergence, can be used to measure the distance between data distributions in different time periods.

In some embodiments, ML monitoring application 146 allows the user to define policy 302 through an application programming interface (API) or a user interface, such as a wizard via which the user can input the parameters of policy 302. Policy 302 can be defined to monitor ML model performance or monitor different types of drifts, such as a feature drift, a prediction drift, a label drift, and/or a concept drift. In some embodiments, policies can be configured to monitor any suitable drift requested by the user. In various embodiments, each policy runs on a schedule, such as daily, weekly, monthly, or quarterly, that is defined by the policy. For example, a monthly policy could run every month and compare data from one month to a previous month, a weekly policy could run every week and compare data from one week to a previous week, etc. As another example, a month-to-date versus month policy could run every day and compare data from one month, up to the current day of that month, to all data from a previous month.

ML inputs 306 can include raw data and/or input features consumed by trained ML model 116 in a production environment to generate ML model output predictions. ML outputs 308 are the predictions of trained ML model 116 in the production environment. ML training data 304, which is data used to train trained ML model 116, can optionally be provided to ML monitoring application 146 in some embodiments. Ground truth data (not shown) corresponding to ML outputs 308 by trained ML model 116 can also be provided to ML monitoring application 146 in some embodiments.

Data preparation module 310 receives ML model inputs 306 into trained ML model 116, as well as ML model outputs 308 from trained ML model 116, and data preparation module 310 prepares the received data based on the parameters of policy 302 for the purpose of calculating drift and/or determining the performance of trained ML model 116. Optionally, data preparation module 310 may also receive ML training data 304 and/or ground truth data that can, e.g., be used in comparisons with ML model inputs 306 and outputs 308 to compute drifts. In some embodiments, data preparation module 310 selects data segments, which are portions of the data, based on policy 302 parameters. Returning to the taxi fare prediction example mentioned above, a data segment could be trips from a particular area to another area. In some embodiments, data preparation module 310 can use operators such as AND and/or OR, as specified by a user, to combine and filter different data segments. In some embodiments, in the case of computing feature drift for an ML model that can take as input any number of features, data preparation module 310 selects a subset of features based on the policy 302 parameters. For example, data preparation module 310 could select the top 10 most important features, or a threshold or other mechanism could be used for selecting the subset of features. Data preparation module 310 also selects a time period for the input data based on policy 302 parameters. ML inputs 306 and ML outputs 308 can be received in any technically feasible manner, such as at the time data is input into and output by trained ML model 116, respectively, or at specific scheduled time intervals. Ground truth data may be available partially or not be available at all.

Drift calculation module 312, receives prepared data from data preparation module 310 and calculates a total drift score, as well as ML model performance metrics, based on policy 302 parameters. In some embodiments, drift calculation module 312 can calculate different types of drifts, such as a feature drift, a prediction drift, a label drift, and/or a concept drift. In some embodiments, drift calculation module 312 can be configured to calculate any suitable drift requested by the user. For each type of drift mentioned above, drift calculation module 312 first computes intermediate drift scores by calculating a distance metric between data distributions of individual features at different time periods specified in policy 302. Returning to the taxi fare prediction example, a distance between distributions of each individual feature, such as pickup location, could be computed for two different time periods, such as one month and a previous month, using the PSI metric. A large value for the PSI metric shows that the distribution of specific pickup locations is different between those time periods, and vice versa a low value for the PSI metric shows that the distribution of specific pickup locations is more similar in time periods specified in policy 302.

In the case of feature drift, drift calculation module 312 computes intermediate drift scores for data that is input into the ML model and/or features derived from the input data, while in the case of prediction drift, drift calculation module 312 computes intermediate drift scores based on ML model predictions and/or features derived from such predictions in different time periods. In some embodiments and when dealing with unstructured data such as images and text, drift calculation module 312 can compute intermediate drift scores using features generated by the last numerical layers of the ML model. For example, in the case of a language model, ML monitoring application 146 could monitor changes in the questions that a user asked over time, and drift calculation module 312 could compute an intermediate drift score using embedding features, or features derived from embeddings such as clusters of the embeddings, that are generated by the last few layers of the language model. In such cases, a large magnitude of drift indicates a material change in the questions that the user asked over time. In the case of a language model, ML monitoring application 146 could also compute intermediate drift scores for other features, such as the sentiment of user questions and/or answers generated by the language model, the length of user questions and/or generated answers, the complexity of user questions and/or generated answers, and/or features that are derived from user behaviors, such as how often users ask questions, whether users asked follow-up questions, how users rated generated answers, and/or the like.

After computing intermediate drift scores, drift calculation module 312 aggregates the computed intermediate drift scores to generate a total drift score. In some embodiments, drift calculation module 312 can use equal or different weights for each intermediate drift score to compute the total drift score as a weighted sum of the intermediate drift scores. In some embodiments, drift calculation module 312 can use a subset of features, for which intermediate drift scores were calculated, to aggregate intermediate drift scores of those features. In some embodiments, drift calculation module 312 allows the user to define which features are more important by, for example, giving more weight to some features than others. In some embodiments, drift calculation module 312 can assign larger weights to various most important features so that even small drifts in important features can have an impact on the total drift score, and vice versa for non-important features. Important features can be identified manually by users or programmatically identified by setting a threshold or using any other automated technique(s), including known importance derivation techniques, for selecting a subset of important features.

In some embodiments, drift calculation module 312 can use statistical techniques to compute a total drift score, such as mean, max, min of features, over time. In some embodiments, drift calculation module 312 can also use ground truth data to calculate the performance of an ML model. Depending on the policy 302 parameters, drift calculation module 312 can compute comparison metrics to measure ML model performance, such as MSE, MAE, MAP, for regression models and accuracy, or precision for classification models. In some cases, drift calculation module 312 can use partially available ground truth data to calculate the performance of an ML model. In such cases, drift calculation module 312 can generate flags so that the user knows to wait for more ground truth data to be collected by data preparation module 310.

Alert module 314 receives total drift scores and ML model performance metrics from drift calculation module 312, as well as parameters of policy 302. Given such inputs, alert module 314 generates alerts that can be displayed via user interface 316. An alert is the violation of a particular policy, for example, a feature drift, a drop in model performance, or the like. Alerts are triggered using thresholds defined by a policy (e.g., policy 302) on a model level. For example, in some embodiments, a policy could define that if a total drift score and/or ML model performance metric is above a threshold, an alert is triggered. As a specific example, a policy could define that a particular feature changing by more than 10% triggers an alert. In some embodiments, alert thresholds can be set manually or automatically based on a desired frequency of alerts. For example, the number of alerts generated over a given period of time for different alert thresholds could be predicted using training data that was used to train a machine learning model, and the predicted number of alerts and corresponding thresholds can be displayed to a user who is permitted to select a particular threshold based on a desired frequency of alerts. In some embodiments, policy 302 can also specify different levels of alerts, such as a critical level and a warning level. When alerts are triggered, a user can investigate to understand and resolve the alerts, after which a summary of drift scores and ML model performance metrics displayed by user interface 316 can be updated. In the language model example described above, after an alert is triggered, the user could look into a word cloud of words to understand the actual change in questions that the user asked.

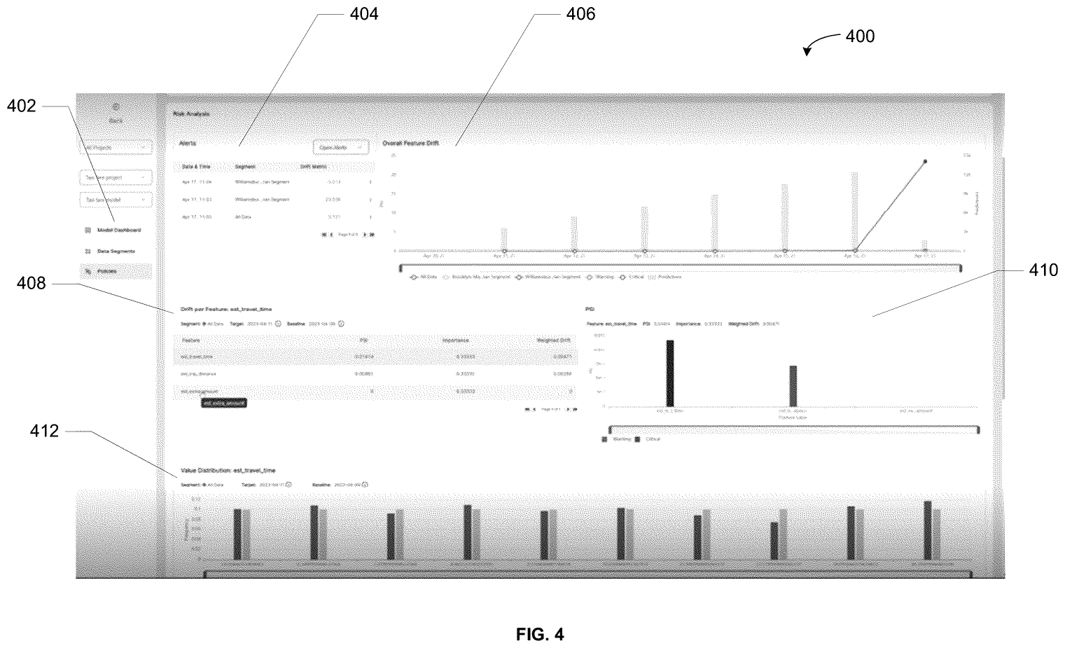

User interface 316 receives alerts from alert module 314 and displays the alerts and/or other information to the user. Depending on the policy, user interface 316 can show the distribution of alerts according to the policy and by segment. User interface 316 can also show other details, such as where alerts came from. For example, UI 316 could show that a particular alert is a performance alert from a feature drifting month to month. User interface 316 can display specific policies and alerts in order to help the user understand what triggered the performance drop. Using user interface 316, a user can go back in time and see what was monitored, how many alerts have been triggered, etc. In some embodiments, in addition to alerts, user interface 316 can display any particular feature at any particular time in a time period, allowing a user to select the feature and see a value distribution of the feature. In such cases, user interface 316 can also display different metrics which can have different sensitivity to the magnitude of drift computed by drift calculation module 312. An exemplar user interface 316 is described in greater detail below in conjunction with FIG. 4.

FIG. 4 illustrates an exemplar user interface 400 generated by ML monitoring application 146 of FIG. 1, according to various embodiments. As shown, user interface 400 includes a side panel 402 that permits a user to select between viewing a model dashboard, data segments, and policies. Illustratively, when viewing of policies is selected, user interface 400 displays parameters of policies used by ML monitoring application 146. A user is also permitted to modify the parameters of policies, such as a list of selected features for each policy, data segments for each policy, etc. Alerts list section 404 shows a list of previously generated alerts by ML monitoring application 146. Illustratively, alert list section 404 also displays information about the alerts, including the date that each alert was triggered, the data segment, and the drift metric score that triggered the alert. A user can scroll through the list of previous alerts in alerts list 404 and investigate an individual previous alert. Overall feature drift section 406 displays the total drift score for different data segments over time. Overall feature drift section 406 can overlay the total drift scores for multiple data segments. Feature list section 408 displays the magnitude of a drift metric, such as PSI, for each feature and the corresponding weights used when computing the total drift score of features specified in a policy. The magnitude of each feature drift metric is also visualized as a bar chart in graph 410. When a user selects a feature from feature list 406, value distribution graph 412 displays the frequency of different values in a distribution of the selected feature next to a baseline value for a specified time period, referred to herein as the baseline time period.

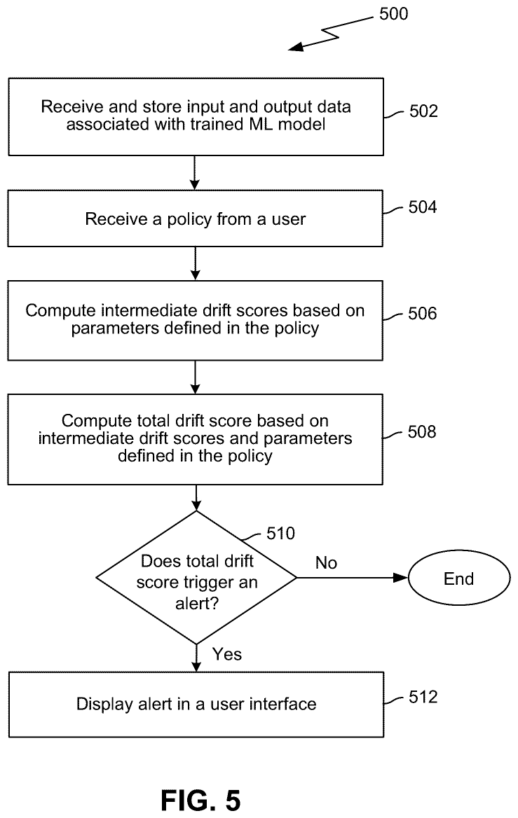

FIG. 5 is a flow diagram of method steps for monitoring a machine learning model performance, according to various embodiments. Although the method steps are described in conjunction with the systems of FIGS. 1-4, persons skilled in the art will understand that any system configured to perform the method steps in any order falls within the scope of the various embodiments.

As shown, a method 500 begins at step 502, where ML monitoring application 146 receives and stores ML input 306 and ML output 308 data associated with trained ML model 116. In some embodiments, ML training data 304 that is the data used to train trained ML model 116 can optionally be provided to ML monitoring application 146. Partial ground truth data corresponding to ML outputs 308 from trained ML model 116 can also be provided to ML monitoring application 146.

At step 504, ML monitoring application 146 receives a policy 302 from a user. Policy 302 specifies configuration parameters that describe how the ML model is monitored. In some embodiments, the parameters specified by policy 302 can include baseline and target time periods (e.g., month-to-month, month-to-date versus month, week-to-week, etc.) for comparing data, data segments, features being monitored, comparison metrics, thresholds for triggering alerts, the type of ML model drift being monitored, and/or the like.

At step 506, ML monitoring application 146 computes intermediate drift scores based on parameters defined in policy 302. In some embodiments, drift calculation module 312 can calculate different types of drifts, such as a feature drift, a prediction drift, a label drift, and/or a concept drift. In some embodiments, drift calculation module 312 can calculate any other drift specified by the user. For each type of drift described above, drift calculation module 312 computes intermediate drift scores by measuring a distance metric between data distributions of individual features at different time periods specified by policy 302. Returning to the taxi fare prediction model example, the distance between distributions of individual features (e.g., pickup location) in two different time periods could be computed using the PSI metric. A large value for the PSI metric shows that the distribution of a specific pickup location is different between time periods specified in policy 302, and vice versa a low value for the PSI metric shows that the distribution of a specific pickup location is more similar between such time periods.

At step 508, ML monitoring application 146 computes the total drift score based on the intermediate drift scores and the parameters defined in policy 302. After computing all intermediate drift scores, drift calculation module 312 aggregates the intermediate drift scores to obtain the total drift score. In some embodiments, drift calculation module 312 can weight each intermediate drift score equally or using different weights that are included in the parameters of policy 302, and drift calculation module 312 can compute the total drift score as a weighted sum of the intermediate drift scores. In some embodiments, drift calculation module 312 can aggregate a subset of intermediate drifts, such as the intermediate drifts for a subset of features. In some embodiments, drift calculation module 312 can assign larger weights to more important features so that even small drifts in the important features can have an impact on the total drift score, and vice versa for non-important features. In such cases, the important features can be identified either manually by experts or programmatically using a threshold or any other automated technique, including known importance derivation techniques, for selecting a subset of important features.

At step 510, ML monitoring application 146 determines whether the total drift score computed at step 508 triggers an alert. An alert is the violation of a particular policy, for example, a feature drift or a drop in model performance. In some embodiments, alert module 314 monitors different levels of alerts, such as a critical level and a warning level, that are associated with different thresholds. If ML monitoring application 146 determines that the total drift score computed at step 508 is more than a threshold associated with an alert defined by policy 302, the alert is triggered and displayed via user interface 316. If ML monitoring application 146 determines that the total drift score computed at step 508 is less than or equal to the threshold(s) that trigger alert(s) defined by policy 302, method 500 ends.

On the other hand, if ML monitoring application 146 determines at step 510 that an alert is triggered, then at step 512, ML monitoring application 146 displays the alert triggered at step 510 in user interface 316. Depending on the policy, user interface 316 can display a list of alert(s) in any suitable manner, such as by data segment, by the time alert(s) were triggered, or the like. User interface 316 can also display other details, such as the metric values that triggered an alert. For example, user interface 316 could show that a particular alert is a performance alert from a feature drifting month to month. User interface 316 displays specific policies and alerts in order to help a user understand what triggered a performance drop. Using user interface 316, a user can check previous alerts and investigate, understand, and resolve alerts.

In sum, techniques are disclosed for monitoring the performance of ML models running in production environments. To monitor the performance of a ML model running in a production environment, a total drift score is computed to indicate a change in data distributions over time. Data that is input into and/or output by the ML is used at predefined time intervals to compute a set of intermediate drift scores based on a policy that includes user-specified baseline and target time periods for comparison, comparison metrics, and/or a portion, also referred to herein as a “segment,” of the data to be compared. The computed intermediate drift scores are then aggregated using weights to compute the total drift score. In some embodiments, the intermediate and/or total drift scores, as well as other computed metrics, can be presented to a user via a dashboard. The computed total drift score can also be used to generate alerts that are triggered by threshold(s) specified in the policy. In some embodiments, a user can define the policy by specifying (1) the baseline and target time periods for computing the total drift score; (2) data segments to monitor; (3) metrics to compute; (4) frequency of computing the total drift score; and (5) threshold(s) that trigger alerts.

One technical advantage of the disclosed techniques relative to the prior art is that the disclosed techniques can be used to monitor the performance of ML models running in production environments, even when ground truth data is unavailable or partially available. In addition, the disclosed techniques are able to identify relatively slow drifts in data distributions by computing metrics over relatively long time intervals. These technical advantages represent one or more technological improvements over prior art approaches.

1. In some embodiments, a computer-implemented method for monitoring performance of a trained machine learning model comprises receiving at least one of one or more first inputs or one or more first outputs of the trained machine learning model during a first time period, receiving at least one of one or more second inputs or one or more second outputs of the trained machine learning model during a second time period, and computing a data drift score based on the at least one of the one or more first inputs or the one or more first outputs, the at least one of the one or more second inputs or the one or more second outputs, and a predefined policy.

2. The computer-implemented method of clause 1, wherein computing the data drift score comprises computing a first set of features based on the at least one of the one or more first inputs or the one or more first outputs, computing a second set of features based on the at least one of the one or more second inputs or the one or more second outputs, for each feature included in the first set of features, computing an intermediate data drift score based on the feature and a correspond feature included in the second set of features, and computing the data drift score based on the intermediate data drift scores and one or more weights defined in the predefined policy.

3. The computer-implemented method of clauses 1 or 2, wherein the first set of features includes at least one of a sentiment of a question, a length of a question, a complexity of an answer, a cluster of embeddings of questions or answers, or a user behavior.

4. The computer-implemented method of any of clauses 1-3, wherein the predefined policy specifies at least one of a set of features to compute based on the at least one of the one or more first inputs or the one or more first outputs and the at least one of the one or more second inputs or the one or more second outputs, an alert threshold, a frequency with which the data drift score is computed, or a portion of data for which the data drift score is computed.

5. The computer-implemented method of any of clauses 1-4, wherein the at least one of the one or more first inputs or the one or more first outputs includes a user-specified portion of input into the machine learning model or output of the machine learning model during the first time period.

6. The computer-implemented method of any of clauses 1-5, further comprising generating one or more alerts based on the data drift score and a threshold defined in the predefined policy.

7. The computer-implemented method of any of clauses 1-6, wherein the threshold is set based on a number of alerts that are expected to be generated using the threshold.

8. The computer-implemented method of any of clauses 1-7, wherein the first time period is a week-to-date, a month-to-date, a quarter-to-date, or a year-to-date time period, and the second time period is a previous week, a previous month, a previous quarter, or a previous year time period.

9. The computer-implemented method of any of clauses 1-8, wherein the data drift score is further computed based on data used to train the trained machine learning model.

10. The computer-implemented method of any of clauses 1-9, further comprising generating a user interface based on the data drift score.

11. In some embodiments, one or more non-transitory computer-readable media store program instructions that, when executed by at least one processor, cause the at least one processor to perform the steps of receiving at least one of one or more first inputs or one or more first outputs of the trained machine learning model during a first time period, receiving at least one of one or more second inputs or one or more second outputs of the trained machine learning model during a second time period, and computing a data drift score based on the at least one of the one or more first inputs or the one or more first outputs, the at least one of the one or more second inputs or the one or more second outputs, and a predefined policy.

12. The one or more non-transitory computer-readable media of clause 11, wherein computing the data drift score comprises computing a first set of features based on the at least one of the one or more first inputs or the one or more first outputs, computing a second set of features based on the at least one of the one or more second inputs or the one or more second outputs, for each feature included in the first set of features, computing an intermediate data drift score based on the feature and a correspond feature included in the second set of features, and computing the data drift score based on a weighted sum of the intermediate data drift scores, wherein the weighted sum is based on one or more weights defined in the predefined policy.

13. The one or more non-transitory computer-readable media of clauses 11 or 12, wherein the first set of features includes at least one of a sentiment of a question, a length of a question, a complexity of an answer, a cluster of embeddings of questions or answers, or a user behavior.

14. The one or more non-transitory computer-readable media of any of clauses 11-13, wherein the predefined policy specifies at least one of a set of features to compute based on the at least one of the one or more first inputs or the one or more first outputs and the at least one of the one or more second inputs or the one or more second outputs, an alert threshold, a frequency with which the data drift score is computed, or a portion of data for which the data drift score is computed.

15. The one or more non-transitory computer-readable media of any of clauses 11-14, wherein the at least one of the one or more first inputs or the one or more first outputs includes a user-specified portion of input into the machine learning model or output of the machine learning model during the first time period.

16. The one or more non-transitory computer-readable media of any of clauses 11-15, wherein the instructions, when executed by the at least one processor, further cause the at least one processor to perform the steps of generating one or more alerts based on the data drift score and a threshold defined in the predefined policy, and generating a user interface based on the one or more alerts.

17. The one or more non-transitory computer-readable media of any of clauses 11-16, wherein the data drift score is further computed based on data used to train the trained machine learning model.

18. The one or more non-transitory computer-readable media of any of clauses 11-17, wherein the trained machine learning model comprises a trained language model.

19. The one or more non-transitory computer-readable media of any of clauses 11-18, wherein the instructions, when executed by the at least one processor, further cause the at least one processor to perform the step of displaying a user interface that is generated based on the data drift score.

20. In some embodiments, a system comprises one or more memories storing instructions, and one or more processors that are coupled to the one or more memories and, when executing the instructions, are configured to receive at least one of one or more first inputs or one or more first outputs of the trained machine learning model during a first time period, receive at least one of one or more second inputs or one or more second outputs of the trained machine learning model during a second time period, and compute a data drift score based on the at least one of the one or more first inputs or the one or more first outputs, the at least one of the one or more second inputs or the one or more second outputs, and a predefined policy.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for monitoring performance of a trained machine learning model, the method comprising:
receiving at least one of one or more first inputs or one or more first outputs of the trained machine learning model during a first time period;
receiving at least one of one or more second inputs or one or more second outputs of the trained machine learning model during a second time period; and
computing a data drift score based on the at least one of the one or more first inputs or the one or more first outputs, the at least one of the one or more second inputs or the one or more second outputs, and a predefined policy.

2. The computer-implemented method of claim 1, wherein computing the data drift score comprises:
computing a first set of features based on the at least one of the one or more first inputs or the one or more first outputs;
computing a second set of features based on the at least one of the one or more second inputs or the one or more second outputs;
for each feature included in the first set of features, computing an intermediate data drift score based on the feature and a correspond feature included in the second set of features; and
computing the data drift score based on the intermediate data drift scores and one or more weights defined in the predefined policy.

3. The computer-implemented method of claim 1, wherein the first set of features includes at least one of a sentiment of a question, a length of a question, a complexity of an answer, a cluster of embeddings of questions or answers, or a user behavior.

4. The computer-implemented method of claim 1, wherein the predefined policy specifies at least one of a set of features to compute based on the at least one of the one or more first inputs or the one or more first outputs and the at least one of the one or more second inputs or the one or more second outputs, an alert threshold, a frequency with which the data drift score is computed, or a portion of data for which the data drift score is computed.

5. The computer-implemented method of claim 1, wherein the at least one of the one or more first inputs or the one or more first outputs includes a user-specified portion of input into the machine learning model or output of the machine learning model during the first time period.

6. The computer-implemented method of claim 1, further comprising generating one or more alerts based on the data drift score and a threshold defined in the predefined policy.

7. The computer-implemented method of claim 6, wherein the threshold is set based on a number of alerts that are expected to be generated using the threshold.

8. The computer-implemented method of claim 1, wherein the first time period is a week-to-date, a month-to-date, a quarter-to-date, or a year-to-date time period, and the second time period is a previous week, a previous month, a previous quarter, or a previous year time period.

9. The computer-implemented method of claim 1, wherein the data drift score is further computed based on data used to train the trained machine learning model.

10. The computer-implemented method of claim 1, further comprising generating a user interface based on the data drift score.

11. One or more non-transitory computer-readable media storing program instructions that, when executed by at least one processor, cause the at least one processor to perform the steps of:
receiving at least one of one or more first inputs or one or more first outputs of the trained machine learning model during a first time period;
receiving at least one of one or more second inputs or one or more second outputs of the trained machine learning model during a second time period; and
computing a data drift score based on the at least one of the one or more first inputs or the one or more first outputs, the at least one of the one or more second inputs or the one or more second outputs, and a predefined policy.

12. The one or more non-transitory computer-readable media of claim 11, wherein computing the data drift score comprises:
computing a first set of features based on the at least one of the one or more first inputs or the one or more first outputs;
computing a second set of features based on the at least one of the one or more second inputs or the one or more second outputs;
for each feature included in the first set of features, computing an intermediate data drift score based on the feature and a correspond feature included in the second set of features; and
computing the data drift score based on a weighted sum of the intermediate data drift scores, wherein the weighted sum is based on one or more weights defined in the predefined policy.

13. The one or more non-transitory computer-readable media of claim 11, wherein the first set of features includes at least one of a sentiment of a question, a length of a question, a complexity of an answer, a cluster of embeddings of questions or answers, or a user behavior.

14. The one or more non-transitory computer-readable media of claim 11, wherein the predefined policy specifies at least one of a set of features to compute based on the at least one of the one or more first inputs or the one or more first outputs and the at least one of the one or more second inputs or the one or more second outputs, an alert threshold, a frequency with which the data drift score is computed, or a portion of data for which the data drift score is computed.

15. The one or more non-transitory computer-readable media of claim 11, wherein the at least one of the one or more first inputs or the one or more first outputs includes a user-specified portion of input into the machine learning model or output of the machine learning model during the first time period.

16. The one or more non-transitory computer-readable media of claim 11, wherein the instructions, when executed by the at least one processor, further cause the at least one processor to perform the steps of:
generating one or more alerts based on the data drift score and a threshold defined in the predefined policy; and
generating a user interface based on the one or more alerts.

17. The one or more non-transitory computer-readable media of claim 11, wherein the data drift score is further computed based on data used to train the trained machine learning model.

18. The one or more non-transitory computer-readable media of claim 11, wherein the trained machine learning model comprises a trained language model.

19. The one or more non-transitory computer-readable media of claim 11, wherein the instructions, when executed by the at least one processor, further cause the at least one processor to perform the step of displaying a user interface that is generated based on the data drift score.

20. A system, comprising:
one or more memories storing instructions; and
one or more processors that are coupled to the one or more memories and, when executing the instructions, are configured to:
receive at least one of one or more first inputs or one or more first outputs of the trained machine learning model during a first time period,
receive at least one of one or more second inputs or one or more second outputs of the trained machine learning model during a second time period, and
compute a data drift score based on the at least one of the one or more first inputs or the one or more first outputs, the at least one of the one or more second inputs or the one or more second outputs, and a predefined policy.
